(19) United States
(12) Patent Application Publication
(10) Pub. No.: US 2025/0080394 A1
(43) Pub. Date: Mar. 6, 2025

(54) INTERACTIVE ANALYTICS SERVICE FOR ALLOCATION FAILURE DIAGNOSIS IN CLOUD COMPUTING ENVIRONMENT

(71) Applicant: Microsoft Technology Licensing, LLC, Redmond, WA (US)

(72) Inventors: Di WENG, Beijing (CN); Shandan ZHOU, Kirkland, WA (US); Jue ZHANG, Beijing (CN); Bo QIAO, Beijing (CN); Si QIN, Beijing (CN); Karthikeyan SUBRAMANIAN, Redmond, WA (US); Thomas MOSCIBRODA, Bellevue, WA (US)

(21) Appl. No.: 18/457,979

(22) Filed: Aug. 29, 2023

(51) Int. Cl. H04L 41/0631; H04L 41/0604; H04L 41/22; H04L 47/74

(52) U.S. Cl. CPC H04L 41/0631; H04L 41/0627; H04L 41/22; H04L 47/746

(57) ABSTRACT

Interactive analytics are provided for resource allocation failure incidents, which may be tracked, diagnosed, summarized, and presented in near real-time for users and/or platform/service providers to understand the root cause(s) of failure incidents and actual and hypothetical, failed and successful, allocation scenarios. A capacity analyzer simulates an allocation process implemented by a resource allocation platform. The capacity analyzer may determine which resources were and/or were not eligible for allocation for a request, based on information about the resource allocation failure, resources in the region of interest, and constraints associated with the incident, and the resource allocation rules associated with the resource allocation platform. Users may quickly learn whether a request constraint, a requesting entity constraint, a capacity constraint, and/or a resource platform constraint caused a resource allocation incident. The capacity analyzer may proactively monitor performance and generate alerts about failed and/or successful requests in which users may be interested.

### BACKGROUND

Cloud computing refers to the access and/or delivery of computing services and resources, including servers (“cloud servers”), storage (“cloud storage”), databases, networking, software, analytics, and intelligence, over the Internet (“the cloud”). A cloud computing platform may make such services and resources available to user entities, referred to as “tenants,” for fees. A cloud computing platform typically supports multiple tenants, with each tenant accessing a respective portion of the services and resources simultaneously with other tenants accessing other portions of the services and resources. Such a cloud computing platform is considered “multitenant.”

A cloud computing platform may allocate resources to users to process workloads (e.g., applications). A resource may include a virtual machine (VM), which is an emulated computer system that executes in the form of software on the operating system (OS) of a physical host computing device (the “host”). A VM may execute its own OS upon which any number of applications may execute under VM control. Furthermore, multiple VMs may simultaneously execute on a single host. A hypervisor is an application that may be used to create and execute VMs. The hypervisor presents the VMs with a virtual operating platform and manages their execution. VMs may be allocated to users under various pay structures (e.g., pay by subscription, by number of VMs requested, by VM time used, etc.) to execute user workloads. In response to a user request, the cloud computing platform may deploy the requested VMs to servers where they may be utilized by the user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein enable end-to-end (E2E) interactive analytics for resource allocation failures in a cloud computing environment. Resource allocation failure incidents, stemming from allocation requests, may be tracked, diagnosed, summarized, and presented in near real-time for users and/or platform/service providers to understand the root cause(s) of failure incidents and actual and hypothetical, failed and successful, allocation scenarios. A capacity analyzer may simulate an allocate process implemented by a resource allocation platform. The capacity analyzer may determine which resources were and/or were not eligible for allocation for a request based on information about a resource allocation failure, the resources in the region of interest, and the constraints associated with the incident, and the resource allocation rules associated with the resource allocation platform. Users may quickly learn whether a request constraint, a requesting entity constraint, a capacity constraint, and/or a resource platform constraint caused a resource allocation incident. The capacity analyzer may proactively monitor performance and generate alerts about failed and/or successful requests that users may be interested in.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of an example network-based computing system configured to enable interactive analytics for resource allocation failures in a cloud computing environment, in accordance with an embodiment.

FIG. 2 shows a block diagram of an example system that includes an incident manager, a capacity analyzer, a data collector, and a user interface, in accordance with an embodiment.

FIG. 3 shows a block diagram of an example of a capacity diagnoser, in accordance with an embodiment.

FIG. 4 shows an example of a user interface providing interactive analytics information indicating multiple allocation scenarios, including the actual resource allocation failure scenario, in accordance with an embodiment.

FIG. 5 shows a flowchart of a process for providing interactive analytics for resource allocation failures in a cloud computing environment, in accordance with an embodiment.

FIG. 6 shows a flowchart of an example process for determining causes of allocation failures and generating information indicating multiple allocation scenarios, including the actual resource allocation failure scenario, in a cloud computing environment, in accordance with an embodiment.

FIG. 7 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Cloud computing platforms enable users (e.g., customers of cloud computing services) to access a shared pool of computing resources. Virtualization involves simulated versions of computing device (e.g., machine) software or hardware components. A virtual machine (VM) is a digital version of a physical computing device. Virtual machine software can run programs and operating systems, store data, connect to networks, among other computing operations. A VM cloud service involves maintenance, such as updates to computing devices and system monitoring, to maintain computing resources for allocation to fulfill customer requests. For example, VM allocation instances may maintain a cache storing relevant information about computing device inventory, such as device temperatures, allocations, type (e.g., hardware details, such as CPU (central processing unit), memory), software, operating systems, location (e.g., region, zone), etc.

Cloud-based systems utilize compute resources to execute code, run applications, and/or run workloads. Examples of compute resources include, but are not limited to, VMs, VM scale sets, clusters (e.g., Kubernetes clusters), machine learning (ML) workspaces (e.g., a group of compute intensive VMs for training machine learning models and/or performing other graphics processing intensive tasks), serverless functions, and/or other compute resources of cloud computing platforms. Those types of resources are used by users (e.g., customers) to run code, applications, and workloads in cloud environments which they are billed for based on the usage, scale, and compute power the customer consume. A cloud service provider may implement or otherwise use a centralized mechanism (e.g., Azure® Resource Manager™ in Microsoft® Azure® or CloudTrail® in Amazon Web Services®) to monitor and control the creation and/or deployment of compute resources in the cloud computing platform.

Cloud computing customers (e.g., users, entities) may request VM creation in bulk to process workloads. An “entity” may be a user account, a subscription, a tenant, or another entity that is provided services of a cloud computing platform by a cloud service provider. A request may fail due to a lack of capacity. For example, a company may request deployment of thousands of VMs. Customers may request VM allocations to perform one or more tasks. Customers may provide detailed requests related to VMs, such as a selected number of VMs of one or more types, which may be identified by a stock keeping unit (SKU), redundancy, region, zone, security, etc. SKUs may group or categorize VMs (and, in some cases, their underlying compute hardware) into a variety of types, such as general purpose with a balanced CPU-to-memory ratio, compute optimized, high performance compute, memory optimized, storage optimized, graphic processing for graphic rendering and video editing, etc. Each VM type may further include multiple possible VM sizes that may further reflect their underlying compute hardware, including processor type, processing cores, processor speed, networking bandwidth, memory, etc.

A VM deployment may be considered failed even if only one VM out of the group fails to be created or is degraded. Customer resource allocation requests may include one or more constraints, such as an indication of particular types of VMs in particular geographical regions and/or zones within regions to process workloads at particular timeframes. A deployment may fail customer constraints and/or platform constraints. For example, a customer requesting deployment of 500 VMs of a first type in the East region of the USA may receive notice that deployment failed because only 490 VMs are available.

A cloud computing platform may allocate resources to customers to process workloads. A resource may include a virtual machine (VM), e.g., an emulated computer system that executes in the form of software on the operating system of a physical host computing device (the “host”). A VM may execute its own operating system (OS) upon which any number of applications may execute under VM control. Furthermore, multiple VMs may simultaneously execute on a single host. A hypervisor is an application that may be used to create and execute VMs. The hypervisor presents the VMs with a virtual operating platform and manages their execution. Some cloud computing platforms offer virtual machines to users (e.g., customers). The users may request the VMs under various pay structures (e.g., pay by subscription, by number of VMs requested, by VM time used, etc.) to execute user workloads (e.g., applications). In response to a user request, the cloud computing platform may deploy the requested VMs to servers where they may be utilized by the user.

Allocation failures in complex systems may be difficult and time consuming to diagnose, which makes it difficult for users and platform representatives to comprehend how to improve allocation success rates in a timely manner. Identifying the root cause of VM allocation failures is important to develop an efficient mitigation plan and reduce the impact of failures on customer experiences.

The reasons behind failures may be diverse, including capacity issues (e.g., constrained capacity in specific regions), demand issues (e.g., over restrictive constraints specified by customers), platform issues (e.g., incorrect configuration or settings of onboarded capacities), etc. Diagnosing and mitigating VM deployment allocation failures has a heavy human cost. It is labor-intensive and time-consuming to gather all relevant information from logs scattered across databases. The bulk information must be interpreted to attempt to determine root causes. Information interpretations, cause determinations, and mitigation recommendations may be error prone due to system complexity, resulting in increased Time To Mitigate (TTM) and decreased customer experience.

An end-to-end (E2E) interactive analytics service in a resource allocation platform may automatically and systematically detect capacity allocation failures in near-real time, diagnose the root causes of failures in a timely manner, recommend actions to mitigate failure risks, and provide interactive visual analysis for users to understand and implement mitigation to improve allocation success rates. As used herein, “near-real time” refers to a time period in the order of minutes (as opposed to “real-time,” which refers to a time period in the order of milliseconds), such as fifteen minutes, etc. An E2E interactive analytics service may reduce engineering effort, decrease TTM, and increase customer experience.

Embodiments described herein enable end-to-end (E2E) interactive analytics for resource allocation failures in a cloud computing environment. Resource allocation failure incidents, stemming from allocation requests, may be tracked, diagnosed, summarized, and presented in near real-time for users and/or platform/service providers to understand the root cause(s) of failure incidents and actual and theoretical, failed and successful, allocation scenarios. A capacity analyzer may simulate an allocate process implemented by a resource allocation platform. The capacity analyzer may determine which resources were and/or were not eligible for allocation for a request, based on information about the resource allocation failure, the resources in the region of interest, and the constraints associated with the incident, and the resource allocation rules associated with the resource allocation platform. Users may quickly learn whether a request constraint, a requesting entity constraint, a capacity constraint, and/or a resource platform constraint caused a resource allocation incident. The capacity analyzer may proactively monitor performance and generate alerts about failed and/or successful future/prospective/retrospective/theoretical requests in which users may be interested.

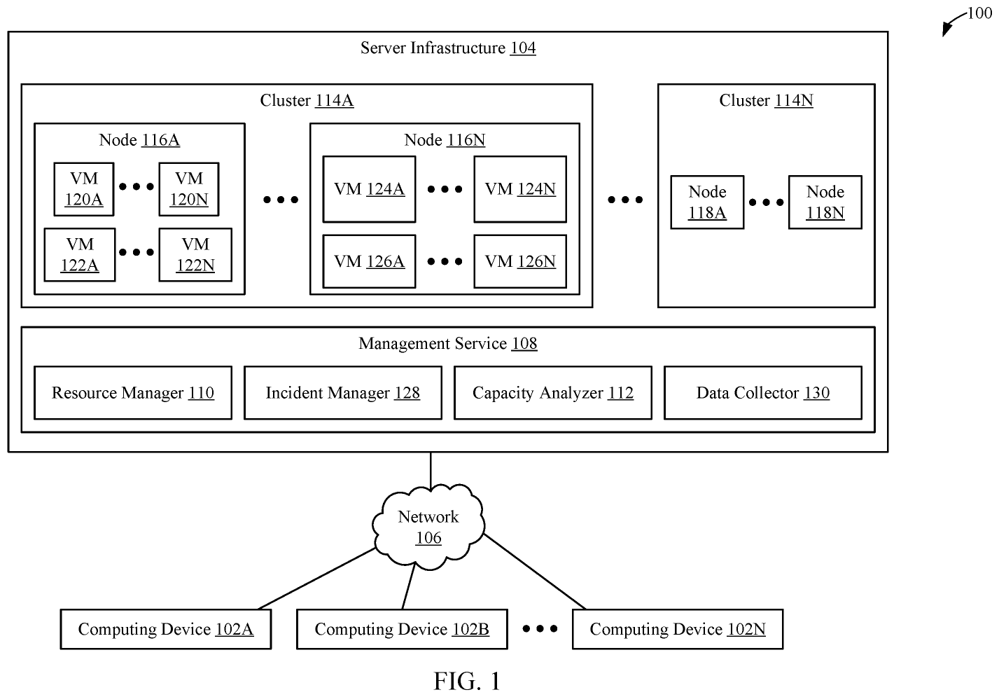

To help illustrate the aforementioned systems and methods, FIG. 1 will now be described. In particular, FIG. 1 shows a block diagram of an example network-based computing system 100 (“system 100” hereinafter) configured to enable interactive analytics for resource allocation failures in a cloud computing environment, in accordance with an embodiment. As shown in FIG. 1, system 100 includes one or more computing devices 102A, 102B, and 102N (collectively referred to as “computing devices 102A-102N”) and a server infrastructure 104. Each of computing devices 102A-102N and server infrastructure 104 are communicatively coupled to each other via network 106. Network 106 may comprise one or more networks such as local area networks (LANs), wide area networks (WANs), enterprise networks, the Internet, etc., and may include one or more of wired and/or wireless portions.

Server infrastructure 104 is an example of resource allocation platform configured to allocate resources in response to requests (e.g., from users) for compute resources such as processors, storage, virtual machines (VMs), software, etc. Server infrastructure 104 may be a network-accessible set of computing devices referred to as a server set (e.g., a cloud-based environment or platform comprising a server inventory). A server inventory may be grouped geographically into regions and zones within regions. Servers may be organized, for example, as racks (e.g., groups of servers), clusters (e.g., groups of racks), data centers (e.g., groups of clusters), etc. As shown in FIG. 1, server infrastructure 104 includes a management service 108 and one or more clusters 114A-114N (collectively referred to as “clusters 114A-114N”). Each of clusters 114A-114N may comprise a group of one or more nodes (also referred to as compute nodes) and/or a group of one or more storage nodes. For example, as shown in FIG. 1, cluster 114A includes nodes 116A-116N and cluster 114N includes nodes 118A-118N. Each of nodes 116A-116N and/or 118A-118N are accessible via network 106 (e.g., in a “cloud-based” embodiment) to build, deploy, and manage applications and services. Any of nodes 116A-116N and/or 118A-118N may be a storage node that comprises a plurality of physical storage disks that are accessible via network 106 and is configured to store data associated with the applications and services managed by nodes 116A-116N and/or 118A-118N.

Groups of clusters in any combination (e.g., cluster 114A, 114A-B, 114A-E, 114G-N, 114A-N) may represent a data center. In an embodiment, one or more of clusters 114A-114N may be co-located (e.g., housed in one or more nearby buildings with associated components such as backup power supplies, redundant data communications, environmental controls, etc.) to form a data center, or may be arranged in other manners. Accordingly, in an embodiment, one or more of clusters 114A-114N may be a data center in a distributed collection of data centers. In accordance with an embodiment, system 100 comprises part of the Microsoft® Azure® cloud computing platform, owned by Microsoft Corporation of Redmond, Washington, although this is only an example and not intended to be limiting.

Each of node(s) 116A-116N and 118A-118N may comprise one or more server computers, server systems, and/or computing devices. Each of node(s) 116A-116N and 118A-118N may be configured to execute one or more software applications (or “applications”) and/or services and/or manage hardware resources (e.g., processors, memory, etc.), which may be utilized by users (e.g., customers) of the network-accessible server set. Node(s) 116A-116N and 118A-118N may be configured for specific uses, e.g., based on allocations to fulfill customer requests. For example, as shown in FIG. 1, node 116A may execute virtual machines (VMs) 120A-120N and VMs 122A-122N and node 116N executes VMs 124A-124N and VMs 126A-126N. In some examples, each node in each cluster may be dynamically configured to execute VMs, VM clusters, ML workspaces, scale sets, etc. in response to customer requests.

As shown in FIG. 1, management service 108 includes a resource manager 110, an incident manager 128, a capacity analyzer 112, and a data collector 130. Management service 108 may be internal and/or external to server infrastructure 104. For instance, management service 108 may be incorporated as a service executing on a computing device of server infrastructure 104. Management service 108 (e.g., or a subservice thereof) may be configured to execute on any of nodes 116A-116N and/or 118A-118N. Alternatively, management service 108 (or a subservice thereof) may be incorporated as a service executing on a computing device external to server infrastructure 104. Furthermore, resource manager 110, incident manager 128, capacity analyzer 112, and/or data collector 130 may be incorporated as the same service or subservice. As shown in FIG. 1, server infrastructure 104 may include a single management service 108; however, it is also contemplated herein that a server infrastructure may include multiple management services. For instance, server infrastructure 104 may include a separate management service for each cluster of clusters 114A-114N (e.g., respective cluster management services).

Computing devices 102A-102N may each be any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. Each of computing devices 102A-102N store data and execute computer programs, applications, and/or services.

Users utilize computing devices 102A-102N to access applications and/or services (e.g., management service 108 and/or subservices thereof, services executing on nodes 116A-116N and/or 118A-118N) offered by the network-accessible server set. For example, a user may be enabled to utilize the applications and/or services offered by the network-accessible server set by signing-up with a cloud services subscription with a service provider of the network-accessible server set (e.g., a cloud service provider). Upon signing up, the user may be given access to a portal of server infrastructure 104, not shown in FIG. 1. A user may access the portal via computing devices 102A-102N (e.g., by a browser application executing thereon). For example, the user may use a browser executing on computing device 102A to traverse a network address (e.g., a uniform resource locator) to a portal of server infrastructure 104, which invokes a user interface (e.g., a web page) in a browser window rendered on computing device 102A. The user may be authenticated (e.g., by requiring the user to enter user credentials (e.g., a username, password, PIN (personal identification number), etc.)) before being given access to the portal. Users may be, for example, customers/clients and/or resource allocation platform representatives (e.g., customer service).

Upon being authenticated, the user may utilize the portal to perform various cloud management-related operations (also referred to as “control plane” operations). Such operations include, but are not limited to, creating, deploying, allocating, modifying, and/or deallocating (e.g., cloud-based) compute resources; building, managing, monitoring, and/or launching applications (e.g., ranging from simple web applications to complex cloud-based applications); configuring one or more of node(s) 116A-116N and 118A-118N to operate as a particular server (e.g., a database server, OLAP (Online Analytical Processing) server, etc.); etc. Examples of compute resources include, but are not limited to, virtual machines, virtual machine scale sets, clusters, ML workspaces, serverless functions, storage disks (e.g., maintained by storage node(s) of server infrastructure 104), web applications, database servers, data objects (e.g., data file(s), table(s), structured data, unstructured data, etc.) stored via the database servers, etc. The portal may be configured in any manner, including being configured with any combination of text entry, for example, via a command line interface (CLI), one or more graphical user interface (GUI) controls, etc., to enable user interaction.

Users may use computing devices 102A-102N to request allocation of VMs by management service 108. Management service 108 may allocate computing devices to fulfill requests based on available inventory. Management service 108 (e.g., resource manager 110) may represent or may include a VM allocation service that receives requests from computing devices 102A-102N to create and allocate virtual machines 120A-120N, 122A-122N, 124A-124N, 126A-126N, etc. There may be multiple instances of management service 108. The inventory managed by each instance may or may not overlap. Each instance may maintain a state of computing devices in the inventory of server infrastructure 104. Inventory may be partitioned, for example, based on servers, racks, clusters, and data centers in various regions and zones.

Resource manager 110 may provide current services to entities, e.g., based on the time of request. Resource manager 110 may receive requests from one or more entities (e.g., via computing devices 102A-102N) for virtual machine (VM) allocation. A (e.g., each) request may include or otherwise indicate one or more parameters (e.g., constraints) indicating, for example, a number of VMs, VM types (e.g., size, SKU, identifier), location (e.g., region(s), zone within region(s)), security (e.g., public key), etc. For example, a request may indicate one or more VM types using a VmSize parameter with a value, such as “Standard_E2s_v3,” “Standard_D2s_v4,” “Standard_D2s_v6,” located in one or more regions or zones, e.g., a first region or a first zone within the first region.

Resource manager 110 may provision a request for VM allocation with available VMs. Resource manager 110 may, e.g., alternatively, determine a capacity shortage of VMs of the requested VM type(s) in the requested region(s) or zone(s) to fulfill the request for VM allocation. Resource manager 110 may notify an entity providing the request (e.g., user/customer using computing device 102A-102N) about allocation success or failure. A user of computing device 102A-102N may respond to a failure, for example, by generating an incident and/or by reformulating the request. Resource manager 110 may, e.g., additionally and/or alternatively, notify incident manager 128 about an allocation failure. Resource manager 110 may generate resource allocation logs, which may indicate the outcomes/results of allocation requests.

Resource manager 110 may (e.g., additionally and/or alternatively) provide historical, present, and/or future-oriented services to entities, such as capacity notifications (e.g., alerts) and/or recommendations, for example, based on information provided by capacity analyzer 112. Resource manager 110 may receive indications from entities that indicate whether entities are participating in receiving notifications and/or recommendations.

Incident manager 128 may monitor resource allocation requests and/or resource allocation request failures. Incident manager 128 may (e.g., automatically) detect allocation failures, for example, based on subscribing to receive failure notification messages generated by resource manager 110. Incident manager 128 may receive (e.g., automated) allocation failure notification from resource manager 110 and/or (e.g., manually entered) allocation failure notification from users of computing device(s) 102A-N. Incident manager 128 may track failure incidents. For example, incident manager 128 may open a ticket for a failure, assign a failure identifier (ID), collect information about failures from one or more sources, such as information generated by data collector 130, information generated by capacity analyzer 112, information provided by users using computing device(s) 102A-102N, and/or information provided by customer service representatives using computing device(s) 102A-102N. Incident manager 128 may trigger data collection (e.g., incident information, resource allocation details, etc.) by data collector 130, failure analysis (e.g., diagnostics) by capacity analyzer 112, and/or failure mitigation operations. For example, incident manager 128 may provide one or more allocation failure parameters to capacity analyzer 112 and/or data collector 130 to generate information for a tracked allocation failure incident.

Data collector 130 may collect information (e.g., data) about resource allocation. Information may pertain to allocation successes and/or failures. Data collector 130 may be triggered to collection information, for example, by resource manager 110, incident manager 128, capacity analyzer 112, etc. For example, data collector 130 may be triggered to collect data pertaining to a failure incident by incident manager 128. Information collected may be stored, for example, as structured data. Information may be collected, for example, in near real-time. For example, data collector 130 may collect information from resource allocation logs associated with resource manager 110. Information may include, for example, resource properties, settings, limits, usage, and allocatable capacity. Data collector 130 may collect information (e.g., resource allocation details) from customers, platform (e.g., customer service) representatives, incident manager 128, and/or resource manager 110 logs (e.g., capacity details, platform configurations). Information may indicate one or more constraints associated with the incident, e.g., request (e.g., specific) constraint(s), customer/requesting entity (e.g., general) constraint(s), regional/zonal capacity constraint(s), and/or resource platform constraint(s). Information collected may (e.g., be useful to) indicate actual and/or theoretical, successful and/or failed, allocation scenarios (e.g., by selecting/deselecting request parameters, platform operating parameters, or constraints) at one or more times (e.g., past, present). Information collected may (e.g., be useful to) indicate one or more root causes of allocation failure.

Capacity analyzer 112 may analyze resource capacity for past and/or present conditions for actual and/or theoretical requests. Capacity analyzer 112 may analyze information available from incident manager 128, resource manager 110, and/or data collector 130, e.g., pertaining to a failed request. For example, capacity analyzer 112 may analyze resource capacity at the time a request was previously made and/or current resource capacity for an actual or prospective/retrospective request (e.g., the same request previously made).

Capacity analyzer may 112 extract activity identifiers (IDs) from available information. Capacity analyzer 112 may detect which allocation failures, identified by activity IDs, are involved in a given incident. Capacity analyzer 112 may detect which allocation failures are involved, for example, by reading a subscription ID associated with an incident. Capacity analyzer 112 may search for the allocation failures associated with a subscription over a relevant time period (e.g., in the past two days). A time period or scope of search may be indicated or determined.

Capacity analyzer 112 may retrieve/obtain resource (e.g., VM cluster) information for region(s) and/or zones in regions pertaining to a request. Capacity analyzer 112 may (e.g., for each allocation failure), obtain a list of resources (e.g., VM clusters) in the requested region(s) that is/are requested to fulfill the request. Capacity analyzer 112 may retrieve relevant information for the resources, which may include, for example, resource properties, settings, actual or estimated capacity, logs, usages, and limits. Information may indicate, for example, capacity constraints and/or resource platform constraints that may impact resource allocation for one or more resources in a region. Capacity analyzer 112 may perform queries (e.g., in structured data) to determine relevant information for resources.

Capacity analyzer 112 may determine resource eligibility for a request. Capacity analyzer 112 may perform/run constraint/validation checks (e.g., in parallel or simultaneously) to determine cluster eligibility. Capacity analyzer 112 may run a set of resource (e.g., VM cluster) validations e.g., (hard constraints) in parallel to determine whether each resource was eligible for allocation in response to a request for allocation. Resource availability validations may be categorized into multiple types, such as customer-side validations and platform-side validations. Customer-side constraints/validations may check/determine resource availability for allocation based on allocation constraints specified in a request or generally applicable based on customer settings, such as a requested region, resource availability zone, network spine, resource features (e.g., ultra solid-state drive (SSD)). The number of resources that satisfy constraints/restrictions may indicate, for example, that a request was too restrictive under one or more (e.g., all) allocation scenarios. Platform-side constraints/validations may determine the eligibility/ineligibility status of resources regardless of request constraints. For example, a validation/constrain may indicate that a VM cluster was temporarily put out of rotation or was (e.g., or would have been) in violation of allocation limits, such as core utilization. A cluster validation operation may return, for example, eligible for a request, ineligible, or “Not Applicable.” An inapplicable validation/constraint may not factor into eligibility of a resource. For example, a prerequisite may not be satisfied, such as requesting features before performing a feature availability validation. Capacity analyzer 112 may generate a message explaining the results of validations performed, for example, to assist with understanding the results.

Capacity analyzer 112 may generate/output root cause analysis (RCA) results. Capacity analyzer 112 may provide results to incident manager 128. For example, capacity analyzer 112 may summarize validation results, e.g., including one or more root causes for allocation failure (e.g., based on incident information). The summary may be associated with a tracked failure incident. Capacity analyzer 112 may organize a summary by subscription and/or by allocation failure. Validation results may be summarized in a table for each failure.

Capacity analyzer 112 may generate a user interface and populate it with information for review on computing device(s) 102A-102N by users (e.g., clients and/or platform representatives). A user interface may be provided for understanding, evaluation, and/or feedback for allocation failures. For instance, the user interface may be configured to present information indicating a plurality of allocation scenarios, including presenting a successful allocation scenario, and may be configured to support interaction with the information to determine the successful allocation scenario from the presented allocation scenarios. A user interface may be selected/opened, for example, via a link attached to a summary report, by querying for an allocation activity ID, and/or by visiting a website providing a Web app user interface.

A user interface may provide multiple panels. For example, an allocation information panel may summarize constraints associated with a requested allocation. A causation panel may enumerate failed validations/constraints. For example, the top five combinations of failed validation with the largest number of failed resources may be listed. A validation panel may indicate resources based on their eligibility/availability and/or ineligibility/unavailability for a requested allocation. Ineligibility may be associated with one or more reasons. For example, a validation panel may deploy a matrix or table to categorize clusters into groups based on failure causes, e.g., singular and/or combined causes. Hovering a cursor over a failure indication may highlight or pop-up resources (e.g., VM cluster groups) that fail the validation and/or show result explanations generated by capacity analyzer 112. Clicking on the resource(s) may open a detail panel, which may summarize relevant resource information.

A user interface may indicate, or may allow users to discover via interaction, multiple allocation scenarios, including actual or hypothetical/theoretical scenarios, failed and/or successful scenarios. For example, a user may select/deselect user-side and/or platform-side constraints to determine how a failed scenario could have or may become a successful scenario historically at the time of the request and/or presently. A user interface may permit a user to navigate between past and current platform conditions/constraints. A user interface may show a capacity graph, indicating region-of-interest capacity past to present.

Management service 108 may provide an E2E system to (e.g., automatically) diagnose allocation failures, e.g., using a data-driven approach to discover hidden knowledge, graph, and correctly interpret the data in alignment with the resource allocation system, determine/generate a result summarization for an incident management system, and provide an interactive user interface for hypothetical (e.g., what if) analyses to expedite an allocation failure mitigation process.

Accordingly, management server 108, and components thereof, have numerous advantages and capabilities. Examples of such advantages and capabilities are listed as follows.

For instance, capacity analyzer 112, data collector 130, and/or incident manager 128 may extract resource allocation information in near real time.

Capacity analyzer 112 may automatically generate a result summary for incident manager 128 (e.g., for a tracked incident).

Capacity analyzer 112 may simulate a resource allocation process, e.g., as may be implemented by resource manager 110. Resource allocation rules may comprise resource platform domain knowledge that simulates a resource allocation process of the resource platform. Capacity analyzer 112 may apply resource allocation rules to user-side and platform side constraints for a set of resources in a region or zone of interest to determine eligible and/or ineligible resources for an actual or hypothetical request. Capacity analyzer 112 may be configured to determine at least one cause of an incident by applying resource allocation rules for the resource platform. Capacity analyzer 112 may build and/or maintain knowledge to simulate the allocation process. For example, capacity analyzer 112 may build an extendable knowledge layer to simulate fixed and variable constraints of the allocation process, which may be used to determine failure causation for resource allocation.

Capacity analyzer 112 may augment the underlying causes of allocation failures, for example, by incorporating domain knowledge to summarize and rank reasons for allocation failure and/or to generate and provide the root cause(s) of failure for incident management.

Capacity analyzer 112 may include an evaluation function that tracks RCA performance, (e.g., automatically) identifies root causes and/or identifies information for further investigation.

Capacity analyzer 112 may provide an interactive user interface for users to verify the RCA and explore hypothetical what-if-analyses for mitigating allocation failures.

Capacity analyzer 112 may present (e.g., selectable/deselectable) constraints for an actual/hypothetical allocation request.

Capacity analyzer 112 may present a select set of root causes from an RCA. Capacity analyzer 112 may list the verification steps of each candidate resource (e.g., VM cluster) according to the request constraints, resource demand constraints, resource capacity constraints, platform constraints, etc.

Capacity analyzer 112 may categorize resources (e.g., VM clusters) into groups based the reasons the resource(s) were ineligible.

Capacity analyzer 112 may present a historical capacity view of a (e.g., each) resource candidate (e.g., VM cluster), which may support investigation/confirmation of the determined RCA by users, engineers and/or incident mitigation experts.

Capacity analyzer 112 may establish a (e.g., systematic) measurement of (e.g., region-of-interest, overall) resource allocation performance by resource manager 110. Capacity analyzer 112 may trigger alerts for (e.g., user) investigation, for example, based on performance measurement (e.g., relative to one or more thresholds).

Capacity analyzer 112 may provide a feedback mechanism, e.g., via the user interface, for users to provide input. Feedback may, for example, update an incident and/or update the platform allocation model used to perform RCA.

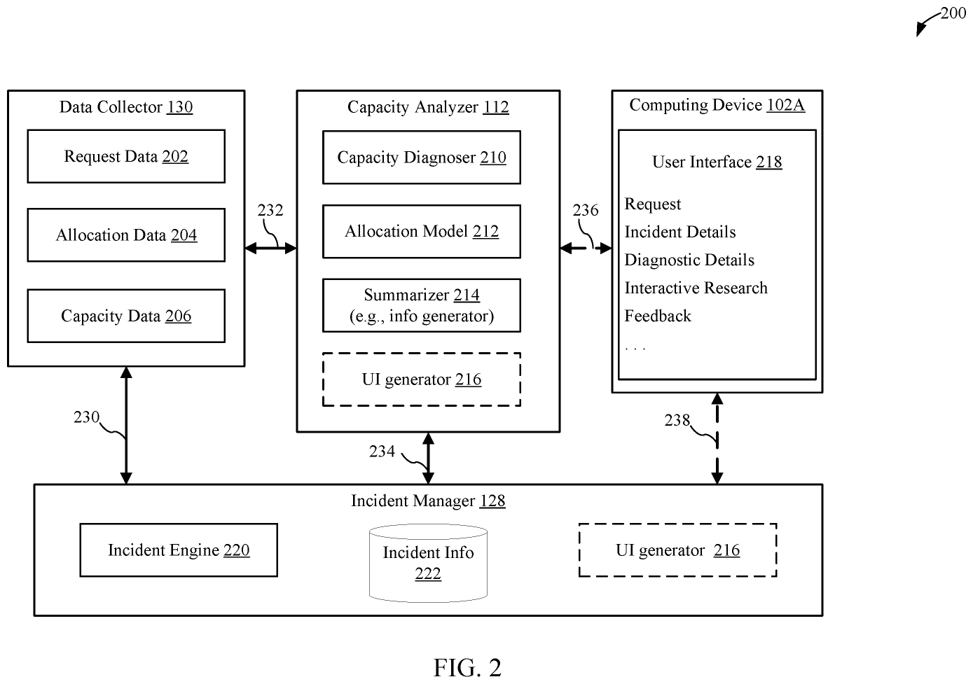

For illustrative purposes, example structure and operation of example system 100 shown in FIG. 1 is described below with respect to FIGS. 2-7.

FIG. 2 shows a block diagram of an example of an incident manager, a capacity analyzer, a data collector and a user interface, in accordance with an embodiment. Example system 200 shows examples of incident manager 128, capacity analyzer 112, data collector 130, and user interface(s) 218 displayed by computing device(s) 102A-102N. As shown in FIG. 2, incident manager 128 may include, e.g., among other components, an incident engine 220, incident information 222, and a UI (user interface) generator 216.

Incident engine 220 may monitor resource allocation requests and/or resource allocation request failures. Incident engine 220 may (e.g., automatically) detect allocation failures, for example, based on failure notification messages received from resource manager 110. Incident manager 128 may receive (e.g., automated) allocation failure notification from resource manager 110 and/or (e.g., manually entered) allocation failure notification from users of computing device(s) 102A-N via user interface 218. Incident engine 220 may track failure incidents. For example, incident engine 220 may open a ticket for a failure, assign a failure identifier (ID), and manage incident information.

Incident engine 220 may trigger data collection by data collector 130, failure analysis (e.g., diagnostics) by capacity analyzer 112, and/or failure mitigation operations, which may be automated and/or manual (e.g., by customer service using user interface 218). For example, incident engine 220 may provide one or more allocation failure parameters for a tracked allocation failure incident to capacity analyzer 112 and/or data collector 130 to generate information for the tracked allocation failure incident. Parameters provided may include, for example, request ID, customer ID, failure code, etc.

Incident engine 220 may manage incident data generated for tracked incidents. Incident engine 220 may collect, store, and manage incident information (info) 222 from one or more sources, such as information from data collector 130, capacity analyzer 112, and/or users (e.g., customers, customer service) using user interface 218. For example, incident engine 220 may receive incident data 202, allocation trace data 204, and capacity data 206 from data collector 130, an incident RCA and summary from capacity analyzer 112, and/or feedback via user interface 218. Incident info 222 may store information or links to information stored or managed elsewhere. Information collected may be stored, for example, as structured data.

UI generator 216 may generate user interface 218, for example, as a Web application accessible by a Web browser executed by computing device(s) 102A-102N. UI generator 216 may populate user interface 218 with initial information and selected incident info 222 for a tracked incident. UI generator 216 may provide user selectable links to incident data in incident info 222 or elsewhere. As indicated by dashed lines, UI generator 216 may be located in one or more components of management service 108. UI 218 may be a downloadable application or agent executed by computing device(s) 102A-102N. UI generator 216 may generate user interface 218 and populate it with information for review on computing device(s) 102A-102N by users (e.g., clients and/or platform representatives).

Data collector 130 may collect information (e.g., general and/or specific, past and/or present, information) about resource allocation. Data collector 130 may collect information (e.g., resource allocation details) from customers, platform (e.g., customer service) representatives, incident manager 128, and/or resource manager 110 logs (e.g., capacity details, platform configurations). Information may indicate one or more constraints associated with the incident, e.g., request (e.g., specific) constraint(s), customer/requesting entity (e.g., general) constraint(s), regional/zonal capacity constraint(s), and/or resource platform constraint(s). Information collected may (e.g., be useful to) indicate actual and/or hypothetical/theoretical, successful and/or failed, allocation scenarios (e.g., by selecting/deselecting request parameters, platform operating parameters, or constraints) at one or more times (e.g., past, present). Information collected may (e.g., be useful to) indicate one or more root causes of allocation failure.

Data collector 130 may be triggered to collect information, for example, by incident manager 128 and/or capacity analyzer 112. For example, data collector 130 may be triggered by communications (e.g., a message) 230 from incident engine 220 to collect data pertaining to a failure incident. Data collector 130 may receive one or more incident parameters in message 230, such as, for example, request ID, customer ID, failure code, etc. In some examples, data collector 230 may continuously or periodically collect resource allocation related information for successful and/or failed resource allocation transactions. Data collector 230 may collect information, for example, in near real-time. For example, data collector 130 may collect information from resource allocation logs associated with resource manager 110.

For example, as shown in FIG. 2, data collector 130 may collect, e.g., among other data, request data 202, allocation data 204, and capacity data 206. Request data 202 may include, for example, requests, request IDs, request times, customer ID, request constraints (e.g., regions, zones, resource type(s)), request results (e.g., success, failure). Allocation data 204 may include, for example, status (e.g., resources allocated or not allocated, failure code(s)), resources allocated by resource manager 110, utilization runtime, etc. Capacity data 206 may include, for example, resource allocation platform configuration, resource (e.g., VM cluster) properties, settings, limits, usage, allocatable capacity, etc.

Data collector 130 may store or return collected data to a requestor, such as capacity analyzer 112 and/or incident manager 128. For example, data collector may collect/provide data 230 in communication 230 (e.g., a request/response procedure) with incident manager 128 or in communication 232 (e.g., a request/response procedure) with capacity analyzer 112.

Capacity analyzer 112 may analyze platform resource capacity for past and/or present conditions for actual and/or hypothetical/theoretical requests. Capacity analyzer 112 may analyze information available from incident manager 128, resource manager 110, and/or data collector 130, e.g., pertaining to a failed request. For example, capacity analyzer 112 may analyze resource capacity at the time a request was previously made and/or current resource capacity for an actual or prospective/retrospective request (e.g., the same request previously made). Capacity analyzer 112 may include, e.g., among other components, capacity diagnoser 210, allocation model 212, summarizer 214, and UI generator 216.

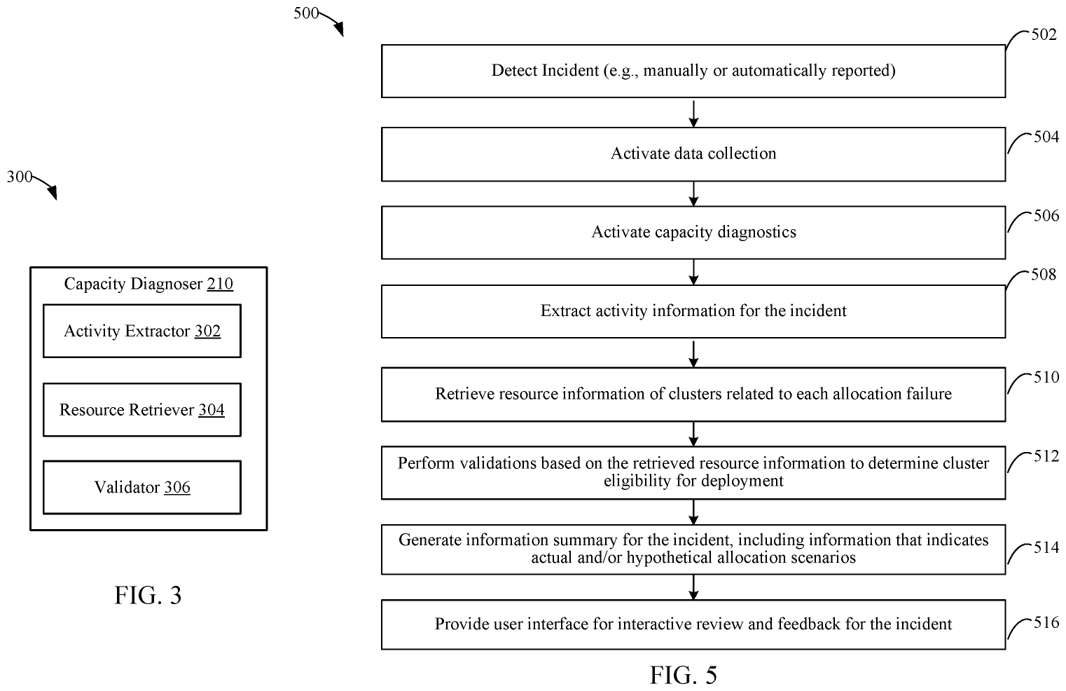

Capacity diagnoser 210 may perform a root cause analysis (RCA) and generate RCA results. Capacity diagnose functions/operations may be separated, for example, as shown in FIG. 3. FIG. 3 shows a block diagram of an example of a capacity diagnoser, in accordance with an embodiment. As shown in FIG. 3, capacity diagnoser 210 may include activity extractor 302, resource retriever 304, and validator 306.

Capacity diagnoser 210 (e.g., activity extractor 302) may extract activity identifiers (IDs) from available information (e.g., incident info 222, allocation data 204). Activity extractor 302 may detect which allocations (e.g., allocation failures), identified by activity IDs, are involved in a given (e.g., successful or failed) allocation. Activity extractor 302 may detect which allocation failures are involved, for example, by reading a subscription ID associated with an incident. Activity extractor 302 may search for the allocation failures associated with a subscription over a relevant time period (e.g., in the past two days). A time period or scope of search may be indicated (e.g., as a parameter in a search request) or determined (e.g., based on a request ID parameter).

Capacity diagnoser 210 (e.g., resource retriever 304) may perform queries of available information (e.g., capacity data 206, allocation data 204) to determine relevant information for resources. Resource retriever 304 may request/receive capacity/allocation data or a link to the data from data collector 130 via communication 232. Resource retriever 304 may retrieve/obtain resource (e.g., VM cluster) information for region(s) and/or zones in regions pertaining to a request. Resource retriever 304 may (e.g., for each allocation failure), obtain a list of resources (e.g., VM clusters) in the requested region(s). Resource retriever 304 may retrieve relevant information for the resources, which may include, for example, resource properties, settings, actual or estimated capacity, logs, usages, and usage limits. Information may indicate, for example, capacity constraints and/or resource platform constraints that may impact resource allocation for one or more resources in a region.

Capacity diagnoser 210 (e.g., validator 306) may determine resource eligibility for a request, for example, by applying request data 202, allocation data 204, and capacity data 206 to allocation model 212. Validator 306 may perform/run constraint/validation checks (e.g., in parallel or simultaneously) to determine resource (e.g., VM cluster) eligibility for a request 236 submitted by a user via computing device(s) 102A-102N. Validator 306 may run a set of resource (e.g., VM cluster) validations e.g., (hard constraints) in parallel to determine whether each resource in a region and/or zone of interest for a request was eligible for allocation in response to a request for allocation. Resource availability validations may be categorized into multiple types, such as customer-side validations and platform-side validations. Customer-side constraints/validations may determine resource availability for allocation based on allocation/request constraints specified in a request or generally applicable based on customer settings, such as a requested region, resource availability zone, network spine, resource features (e.g., ultra SSD). The number of resources that satisfy constraints/restrictions may indicate, for example, that a request was too restrictive under one or more (e.g., all) allocation scenarios. Platform-side constraints/validations may determine the eligibility/ineligibility status of resources regardless of request constraints. For example, a validation/constrain may indicate that a VM cluster was temporarily put out of rotation or was (e.g., or would have been) in violation of allocation limits, such as core utilization. A cluster validation operation may return, for example, eligible for a request, ineligible, or “Not Applicable.” An inapplicable validation/constraint may not factor into eligibility of a resource.

Capacity analyzer 112 or a component thereof, such as capacity diagnoser 210 (e.g., validator 306), may include an evaluation function that tracks RCA performance, (e.g., automatically) identifies root causes and/or identifies information for further investigation, as may be summarized by summarizer 214 for user interface 218. Capacity diagnoser 210 (e.g., validator 306) may establish a (e.g., systematic) measurement of resource allocation performance by resource manager 110, e.g., in one or more regions. Capacity diagnoser 210 (e.g., validator 306) may trigger alerts for (e.g., user) investigation, for example, based on performance measurement (e.g., relative to one or more thresholds).

Allocation model 212 may comprise resource allocation rules to user-side and platform side constraints for a set of resources in a region or zone of interest. Allocation model 212 may be used to determine eligible and/or ineligible resources for an actual or hypothetical request. Capacity diagnoser 210 (e.g., validator 306) may use allocation model 212 to simulate a resource allocation process, e.g., as may be implemented by resource manager 110 and/or other components of management service 108. Capacity analyzer 112 may build and/or maintain knowledge to simulate the allocation process. For example, capacity analyzer 112 may build an extendable knowledge layer to simulate fixed and variable constraints of the allocation process, which may be used by capacity diagnoser 210 to determine failure causation for resource allocation. Capacity analyzer 112 may augment the underlying causes of allocation failures, for example, by incorporating domain knowledge to summarize and rank reasons for allocation failure and/or to generate and provide the root cause(s) of failure for incident management.

Summarizer 214 may (e.g., automatically) generate an RCA result summary for incident manager 128 (e.g., for a tracked incident). For example, summarizer 214 may summarize validation results and send the summary in communication 234 to incident manager 128 to associate with a tracked failure incident in incident info 222 and/or provide the summary to user interface 218 via communication 236, which may include UI generator 216 communicating with computing device 102A to provide user interface 218 and/or information to populate user interface 218. Summarizer 214 may organize a summary by entity/customer subscription and/or by allocation failure. Validation results may be summarized in a table for each failure. Summarizer 214 may generate a message explaining the results of validations performed, for example, to assist with understanding the results. Summarizer 214 may provide RCA results to incident manager 128, UI generator 216, and/or user interface 218, for example, depending upon implementation of user interface 218 as a Web application, stand-alone application, agent of server process, etc.

UI generator 216 may generate user interface 218, for example, as a Web application accessible by a Web browser executed by computing device(s) 102A-102N. User interface 218 may indicate, or may allow users to discover via interaction, multiple allocation scenarios, including actual or hypothetical/theoretical scenarios, failed and/or successful scenarios. For example, a user may select/deselect user-side and/or platform-side constraints to determine how a failed scenario could have or may become a successful scenario historically at the time of the request and/or presently. User interface 218 may permit a user to navigate between past and current platform conditions/constraints. User interface 218 may show a capacity graph, indicating region-of-interest capacity past to present.

UI generator 216 may populate user interface 218 with information, e.g., including selectable incident information, which may include request data 202, allocation data 204, capacity data 206, incident info 222, diagnostic information (e.g., root cause(s)) generated by capacity analyzer 112, etc. UI generator 216 may provide user selectable links to incident data in incident info 222 or elsewhere. As indicated by dashed lines, UI generator 216 may be located in one or more components of management service 108. UI 218 may be a downloadable application or agent executed by computing device(s) 102A-102N. UI generator 216 may generate user interface 218 and populate it with information for review on computing device(s) 102A-102N by users (e.g., clients and/or platform representatives).

Computing device(s) 102A-102N may execute and/or display user interface 218, e.g., at least in part, for understanding, evaluation, and/or feedback for allocation failures. User interface 218 may be selected/opened, for example, via a link attached to a summary report, by querying for an allocation activity ID, and/or by visiting a website providing a Web app user interface. Computing device 102A may obtain user interface 218 and/or information shown in user interface 218 via communication 238 with incident manager 128 and/or communication 236 with capacity analyzer 112, which may include an exchange of messages (e.g., request/response messages).

User interface 218 may display, for example, the request of interest, allocation details (e.g., failure incident), diagnostic details, interactive research (e.g., selectable/unselectable constraints to show the actual or hypothetical results for actual or hypothetical requests at actual or hypothetical times), feedback, etc. User interface 218 may be an interactive user interface for users to verify the RCA for an incident and explore hypothetical what-if analyses for mitigating allocation failures.

User interface 218 may present (e.g., selectable/deselectable) constraints for an actual and/or a hypothetical allocation request. User interface 218 may present a selectable/deselectable set of root causes from an RCA.

User interface 218 may show/list the verification steps of each candidate resource (e.g., VM cluster) according to the request constraints, resource demand constraints, resource capacity constraints, platform constraints, etc. evaluated by capacity analyzer 112. User interface 218 may categorize resources (e.g., VM clusters) into groups based the reasons the resource(s) were ineligible.

User interface 218 may present a historical capacity view of a (e.g., each) resource candidate (e.g., VM cluster), which may support investigation/confirmation of the determined RCA by users, engineers and/or incident mitigation experts.

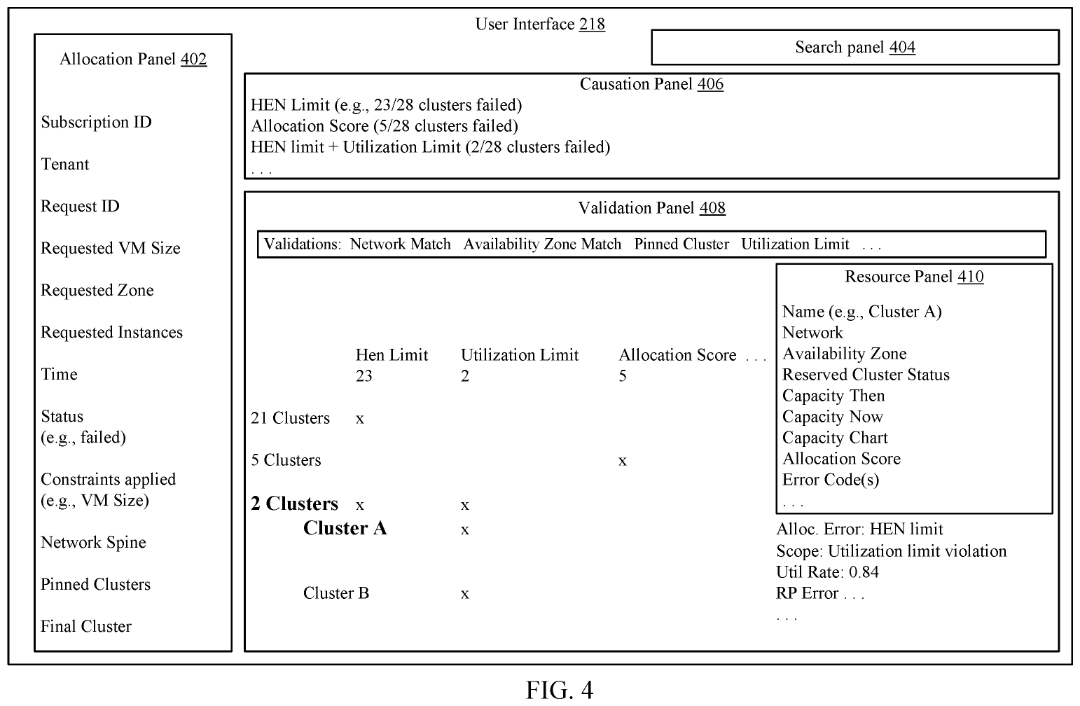

User interface 218 may provide a feedback mechanism, e.g., via the user interface, for users to provide input. Feedback may, for example, update an incident and/or update the platform allocation model used to perform RCA. An example of user interface 218 is shown in FIG. 4.

FIG. 4 shows an example of a user interface providing interactive analytics information indicating multiple allocation scenarios, including the actual resource allocation failure scenario, in accordance with an embodiment. As shown by example in FIG. 4, user interface 218 may organize information into multiple panels or windows, such as an allocation panel 402, search panel 404, causation panel 406, validation panel 408, and resource panel 410.

Search panel 404 may be used to search for information using any searchable term, such as a request ID, allocation ID, date, time, result (e.g., success, failure), customer ID, resources, and so on. Search results may be displaying in a pop up to browse and select links to information.

Allocation panel 402 may provide allocation information, which may summarize information about a request, allocation result, client/customer, request constraints, platform constraints, etc. that may be associated with a requested allocation. For example, as shown by example in allocation panel 402, constraints may include requested VM size, requested zone, requested instances, VM size, etc. Platform information may include, for example, network spine, pinned clusters, final cluster, etc.

Causation panel 406 may enumerate root causes of a failure incident, e.g., failed validations/constraints. For example, the most influential (e.g., five) combinations of failed validations with the largest number of failed resources may be listed in causation panel 406. As shown by example in causation panel 406, 23 of 28 potential clusters failed allocation/validation based on a HEN (Healthy Empty Node) limit, five (5) of the 28 potential clusters failed allocation/validation based on their allocation score, and two (2) of the 28 potential clusters failed allocation/validation based on a combination of HEN limit and utilization limit constraints.

Details of these root causes of failure summarized in causation panel 406 may be provided in validation panel 408, where a user may select and deselect root causes to peruse multiple allocation scenarios, including the actual allocation scenario and hypothetical scenarios, which may be indicated to have been successful or not based on available information at the time of the actual request or another time, such as under present or nearly present/recent past conditions.

As shown by example in validation panel 408, resources (e.g., VM clusters) may be shown based on their eligibility/availability and/or ineligibility/unavailability for a requested allocation. Ineligibility may be associated with one or more reasons or causes. For example, validation panel 408 may show a matrix or table to categorize clusters into groups based on failure causes, e.g., singular and/or combined causes. Users may select validations/constraints, such as network match, availability zone match, pinned cluster, utilization limit, etc. to display results for a selected scenario based on a selected set of requests and/or platform constraints. As shown in validation panel 408, a user selected a scenario with HEN limit, utilization limit, allocation score, etc. to see how many resources were eligible/ineligible. Similar to the summary shown in causation panel 406, the selected validations/constraints show that 23 of 28 potential clusters failed allocation/validation based on a HEN limit, two (2) of the 28 potential clusters failed allocation/validation based on utilization limit, and five (5) of the 28 potential clusters failed allocation/validation based on their allocation score. The two clusters, cluster A and cluster B, which failed based on HEN limit and utilization limit, are shown to have received a HEN limit violation and a utilization limit violation based on a utilization rate of 0.84, as indicated by a resource provider (RP) error. A user may select different validations to check hypothetical and actual allocation results. As shown in FIG. 4, hovering a cursor over or otherwise selecting (e.g., clicking on) a resource (e.g., Cluster A in bold) may highlight or pop-up resource panel 410 to show details for the selected resource.

Resource panel 410 may show details for a selected resource. Resource panel 410 may show details for resources that failed the validation/constraint(s), which may include result explanations generated by capacity diagnoser 210. As shown by example in resource panel 410, details, such as name (e.g., cluster A), network, availability zone, reserved cluster status, capacity then, capacity now, capacity chart, allocation score, error code(s), etc., may be shown for the selected resource (e.g., cluster A). A user may select details, such as capacity chart, to see details (e.g., a historical capacity chart for cluster A for a time period that may be selectable).

The example of management service 108 described herein may provide an E2E system to (e.g., automatically) diagnose allocation failures, e.g., using a data-driven approach to discover hidden knowledge, graph, and correctly interpret the data in alignment with the resource allocation system, determine/generate a result summarization for an incident management system, and provide an interactive user interface for hypothetical (e.g., what if) analyses to expedite an allocation failure mitigation process. Capacity analyzer 112, data collector 130, and/or incident manager 128 may extract and process resource allocation information in near real time, which may allow users to quickly determine root causes and mitigate failures under prevailing platform conditions.

FIG. 5 shows flowchart 500 of an example process for providing interactive analytics for resource allocation failures in a cloud computing environment, in accordance with an embodiment. Management service 108 of FIG. 1 may operate according to flowchart 500, for example, in one or more embodiments. Note that not all steps of flowchart 500 need be performed in all embodiments. Further structural and operational embodiments will be apparent to persons skilled in the relevant art(s) based on the following description.

Flowchart 500 begins with step 502. In step 502, an incident may be detected (e.g., manually or automatically reported). For example, as shown in FIGS. 1 and 2, incident manager 128 may receive an indication from resource manager 110 and/or user interface 218 that a resource allocation failure occurred.

In step 504, data collection may be activated. For example, as shown in FIGS. 1 and 2, incident manager 128 (e.g., incident engine 220 of FIG. 2) may trigger data collector 130 to collect information about the allocation failure incident.

In step 506, capacity diagnostics may be activated. For example, as shown in FIGS. 1 and 2, incident manager 128 may trigger capacity analyzer 112 (e.g., capacity diagnoser 210) to determine the root cause(s) of the resource allocation failure, e.g., upon completion of data collection by data collector 130.

In step 508, activity information for the incident may be extracted. For example, as shown in FIGS. 1-3, capacity analyzer 112, per capacity diagnoser 210 (e.g., activity extractor 302), may extract allocation activity information from allocation data 204 collected by data collector 130. In an embodiment, activity extractor 302 may be configured to detect which allocation failures, as identified by activity identifiers, are involved in the given incident. Thus, activity extractor 302 may extract (e.g., read) activity information such as a subscription identifier associated with the incident, and based thereon, determine further activity information, such as further allocation failures associated with the subscription identifier's subscription that occurred in an immediately prior time period (e.g., two days).

In step 510, resource information for the requested region may be retrieved. For example, as shown in FIGS. 1-3, capacity analyzer 112, per capacity diagnoser 210 (e.g., resource retriever 304), may determine resource information from allocation data 204 and/or capacity data 206 collected by data collector 130. In an embodiment, resource retriever 304 is configured to obtain resource information, such as a list of clusters in the requested region (e.g., the region in which the request originated) and further resource information, for each of the listed clusters, including the cluster properties, settings, estimated capacity, logs, usages, and limits (e.g., such as by running queries).

In step 512, validations may be performed to determine cluster eligibility for deployment based on constraints applied to allocation rules. For example, as shown in FIGS. 1-3, capacity analyzer 112, per capacity diagnoser 210 (e.g., validator 306), may perform validations to determine which resources were or were not eligible for allocation based on user-side and platform-side constraints using allocation model 212, request data 202, allocation data 204, and capacity data 206 collected by data collector 130. For example, in an embodiment, validator 306 is configured to run a set of cluster validations (e.g., hard constraints) parallelly to determine whether each listed cluster is eligible for allocation. In an embodiment, the cluster validations may be categorized into two types: customer-side validations and platform-side validations. Customer-side validations check whether the specified allocation constraints, such as the requested availability zone, T2 network spine, presence of VM features like Ultra SSD, etc., are too restrictive. The platform-side validations check for ineligibility resulted from the status of the clusters. For example, a cluster may be temporarily put out of rotation or violate the allocation limits such as core utilization. The cluster validations can also return “Not Applicable” if the prerequisites, such as the features that should be requested before performing the feature availability validations, are not satisfied. Moreover, a message explaining the results of the validations may be generated to help users better understand the results.

In step 514, an information summary may be generated for the incident (e.g., RCA results), including information that is useful to indicate actual and/or hypothetical allocation scenarios. For example, as shown in FIGS. 1 and 2, summarizer 214 may generate a summary of collected and processed information for UI generator 216 to populate user interface 218 with information a user may interact with to observe actual and hypothetical request and allocation scenarios for past and/or present platform conditions. Furthermore, summarizer 214 may generate the information for UI summarizer 214 to include recommended actions to mitigate failure risks, and provide interactive visual analysis for users to understand and implement mitigation to improve allocation success rates.

In step 516, a user interface may be provided for interactive review and feedback for the incident. For example, as shown in FIGS. 1 and 2, UI generator 216 may generate user interface 218 with the collected and processed information that a user may interact with to observe actual and hypothetical request and allocation scenarios for past and/or present platform conditions, and provide feedback for the incident.

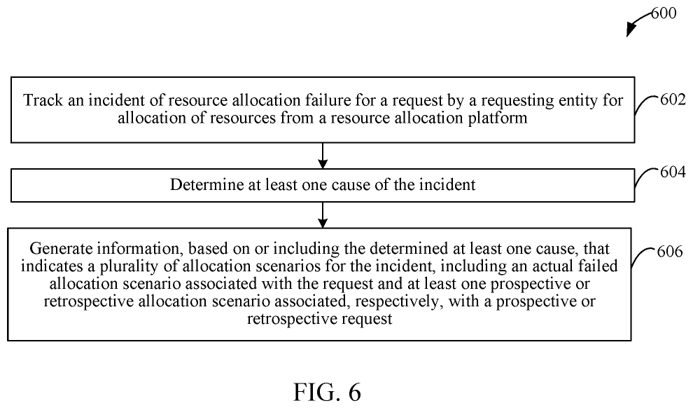

FIG. 6 shows a flowchart 600 of an example process for determining causes of allocation failures and generating information indicating multiple allocation scenarios, including the actual resource allocation failure scenario, in a cloud computing environment, in accordance with an embodiment. Management service 108 of FIG. 1 may operate according to flowchart 600, for example, in one or more embodiments. Note that not all steps of flowchart 600 need be performed in all embodiments. Further structural and operational embodiments will be apparent to persons skilled in the relevant art(s) based on the following description.

Flowchart 600 begins with step 602. In step 602, tracking may be implemented for an incident of resource allocation failure for a request by a requesting entity for allocation of resources from a resource allocation platform. For example, as shown in FIGS. 1 and 2, incident manager 128 (e.g., incident engine 220) may track the incident. Incident manager 128 may trigger data collector 130 to collect information about the allocation failure incident. Incident manager 128 may trigger capacity analyzer 112 (e.g., capacity diagnoser 210) to determine the root cause(s) of the resource allocation failure.

In step 604, at least one cause of the incident may be determined. For example, as shown in FIGS. 1-3, capacity analyzer 112, per capacity diagnoser 210 (e.g., validator 306), may determine one or more causes of allocation failure by performing validations to determine which resources were or were not eligible for allocation based on user-side and platform-side constraints using allocation model 212, request data 202, allocation data 204, and capacity data 206 collected by data collector 130. In an embodiment, capacity analyzer 112 may execute flowchart 500 to determine the at least one cause of the incident.

In step 606, information may be generated, based on or including the determined at least one cause, that indicates a plurality of allocation scenarios for the incident, including an actual failed allocation scenario associated with the request. For example, as shown in FIGS. 1 and 2, summarizer 214 may generate a summary of collected and processed information for UI generator 216 to populate user interface 218 with information a user may interact with to observe actual and hypothetical request and allocation scenarios for past and/or present platform conditions.

### III. Example Computing Device Embodiments

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

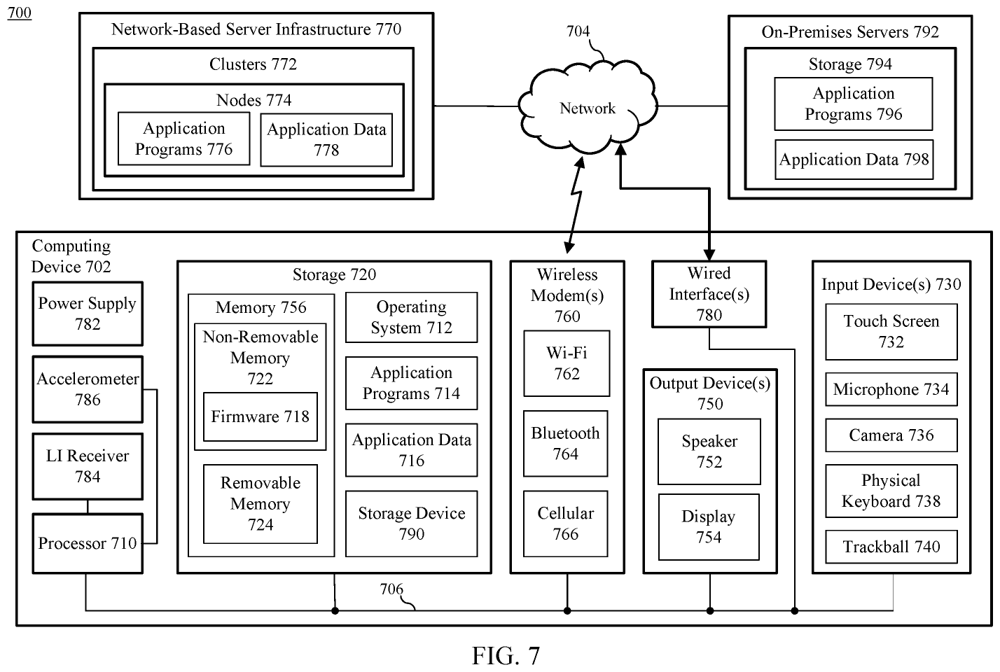

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 7. FIG. 7 shows a block diagram of an exemplary computing environment 700 that includes a computing device 702. Computing device 702 is an example of computing device 102A-102N, node 116A-N, node 118A-N, and/or another computing device of server infrastructure 104 as described with respect to FIG. 1, each of which may include one or more of the components of computing device 702. In some embodiments, computing device 702 is communicatively coupled with devices (not shown in FIG. 7) external to computing environment 700 via network 1004. Network 704 is an example of network 106 of FIG. 1. Network 704 comprises one or more networks such as local area networks (LANs), wide area networks (WANs), enterprise networks, the Internet, etc., and may include one or more wired and/or wireless portions. Network 704 may additionally or alternatively include a cellular network for cellular communications. Computing device 1002 is described in detail as follows.

Computing device 702 can be any of a variety of types of computing devices. For example, computing device 702 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 702 may alternatively be a stationary computing device such as a desktop computer, a personal computer (PC), a stationary server device, a minicomputer, a mainframe, a supercomputer, etc.

As shown in FIG. 7, computing device 702 includes a variety of hardware and software components, including a processor 710, a storage 720, one or more input devices 730, one or more output devices 750, one or more wireless modems 760, one or more wired interfaces 780, a power supply 782, a location information (LI) receiver 784, and an accelerometer 786. Storage 720 includes memory 756, which includes non-removable memory 722 and removable memory 724, and a storage device 790. Storage 720 also stores an operating system 712, application programs 714, and application data 716. Wireless modem(s) 760 include a Wi-Fi modem 762, a Bluetooth modem 764, and a cellular modem 766. Output device(s) 750 includes a speaker 752 and a display 754. Input device(s) 730 includes a touch screen 732, a microphone 734, a camera 736, a physical keyboard 738, and a trackball 740. Not all components of computing device 702 shown in FIG. 7 are present in all embodiments, additional components not shown may be present, and any combination of the components may be present in a particular embodiment. These components of computing device 702 are described as follows.

A single processor 710 (e.g., central processing unit (CPU), microcontroller, a microprocessor, signal processor, ASIC (application specific integrated circuit), and/or other physical hardware processor circuit) or multiple processors 710 may be present in computing device 702 for performing such tasks as program execution, signal coding, data processing, input/output processing, power control, and/or other functions. Processor 710 may be a single-core or multi-core processor, and each processor core may be single-threaded or multithreaded (to provide multiple threads of execution concurrently). Processor 710 is configured to execute program code stored in a computer readable medium, such as program code of operating system 712 and application programs 714 stored in storage 720. Operating system 712 controls the allocation and usage of the components of computing device 702 and provides support for one or more application programs 714 (also referred to as “applications” or “apps”). Application programs 714 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 702 can communicate with any other component according to function, although not all connections are shown for ease of illustration. For instance, as shown in FIG. 7, bus 706 is a multiple signal line communication medium (e.g., conductive traces in silicon, metal traces along a motherboard, wires, etc.) that may be present to communicatively couple processor 710 to various other components of computing device 702, although in other embodiments, an alternative bus, further buses, and/or one or more individual signal lines may be present to communicatively couple components. Bus 706 represents one or more of any of several types of bus structures, including a memory bus or memory controller, a peripheral bus, an accelerated graphics port, and a processor or local bus using any of a variety of bus architectures.

Storage 720 is physical storage that includes one or both of memory 756 and storage device 790, which store operating system 712, application programs 714, and application data 716 according to any distribution. Non-removable memory 722 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 722 may include main memory and may be separate from or fabricated in a same integrated circuit as processor 710. As shown in FIG. 7, non-removable memory 722 stores firmware 718, which may be present to provide low-level control of hardware. Examples of firmware 718 include BIOS (Basic Input/Output System, such as on personal computers) and boot firmware (e.g., on smart phones). Removable memory 724 may be inserted into a receptacle of or otherwise coupled to computing device 702 and can be removed by a user from computing device 702. Removable memory 724 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 790 may be present that are internal and/or external to a housing of computing device 702 and may or may not be removable. Examples of storage device 790 include a hard disk drive, a SSD, a thumb drive (e.g., a USB (Universal Serial Bus) flash drive), or other physical storage device.

One or more programs may be stored in storage 720. Such programs include operating system 712, one or more application programs 714, and other program modules and program data. Examples of such application programs may include, for example, computer program logic (e.g., computer program code/instructions) for implementing one or more of management service 108, resource manager 110, capacity analyzer 112, clusters 114A-N, nodes 116A-N, nodes 118A-N, VMs 120A-N, VMs 122A-N, VMs 124A-N, VMs 126A-N, data collector 130, capacity diagnoser 210, summarizer 214, UI generator 216, incident engine 220, activity extractor 302, resource retriever 304, validator 306, along with any components and/or subcomponents thereof, as well as the flowcharts/flow diagrams (e.g., flowcharts 500 and/or 600) described herein, including portions thereof, and/or further examples described herein.

Storage 720 also stores data used and/or generated by operating system 712 and application programs 714 as application data 716. Examples of application data 716 include web pages, text, images, tables, sound files, video data, and other data, which may also be sent to and/or received from one or more network servers or other devices via one or more wired or wireless networks. Storage 720 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 702 through one or more input devices 730 and may receive information from computing device 702 through one or more output devices 750. Input device(s) 730 may include one or more of touch screen 732, microphone 734, camera 736, physical keyboard 738 and/or trackball 740 and output device(s) 750 may include one or more of speaker 752 and display 754. Each of input device(s) 730 and output device(s) 750 may be integral to computing device 702 (e.g., built into a housing of computing device 702) or external to computing device 702 (e.g., communicatively coupled wired or wirelessly to computing device 702 via wired interface(s) 780 and/or wireless modem(s) 760). Further input devices 730 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 754 may display information, as well as operating as touch screen 732 by receiving user commands and/or other information (e.g., by touch, finger gestures, virtual keyboard, etc.) as a user interface. Any number of each type of input device(s) 730 and output device(s) 750 may be present, including multiple microphones 734, multiple cameras 736, multiple speakers 752, and/or multiple displays 754.

One or more wireless modems 760 can be coupled to antenna(s) (not shown) of computing device 702 and can support two-way communications between processor 710 and devices external to computing device 702 through network 704, as would be understood to persons skilled in the relevant art(s). Wireless modem 760 is shown generically and can include a cellular modem 766 for communicating with one or more cellular networks, such as a GSM network for data and voice communications within a single cellular network, between cellular networks, or between the mobile device and a public switched telephone network (PSTN). Wireless modem 760 may also or alternatively include other radio-based modem types, such as a Bluetooth modem 764 (also referred to as a “Bluetooth device”) and/or Wi-Fi 762 modem (also referred to as an “wireless adaptor”). Wi-Fi modem 762 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 764 is configured to communicate with another Bluetooth-capable device according to the Bluetooth short-range wireless technology standard(s) such as IEEE 802.15.1 and/or managed by the Bluetooth Special Interest Group (SIG).

Computing device 702 can further include power supply 782, LI receiver 784, accelerometer 786, and/or one or more wired interfaces 780. Example wired interfaces 780 include a USB port, IEEE 794 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 780 of computing device 702 provide for wired connections between computing device 702 and network 704, or between computing device 702 and one or more devices/peripherals when such devices/peripherals are external to computing device 702 (e.g., a pointing device, display 754, speaker 752, camera 736, physical keyboard 738, etc.). Power supply 782 is configured to supply power to each of the components of computing device 702 and may receive power from a battery internal to computing device 702, and/or from a power cord plugged into a power port of computing device 702 (e.g., a USB port, an A/C power port). LI receiver 784 may be used for location determination of computing device 702 and may include a satellite navigation receiver such as a Global Positioning System (GPS) receiver or may include other type of location determiner configured to determine location of computing device 702 based on received information (e.g., using cell tower triangulation, etc.). Accelerometer 786 may be present to determine an orientation of computing device 702.

Note that the illustrated components of computing device 702 are not required or all-inclusive, and fewer or greater numbers of components may be present as would be recognized by one skilled in the art. For example, computing device 702 may also include one or more of a gyroscope, barometer, proximity sensor, ambient light sensor, digital compass, etc. Processor 710 and memory 756 may be co-located in a same semiconductor device package, such as being included together in an integrated circuit chip, FPGA, or system-on-chip (SOC), optionally along with further components of computing device 702.

In embodiments, computing device 702 is configured to implement any of the above-described features of flowcharts herein. Computer program logic for performing any of the operations, steps, and/or functions described herein may be stored in storage 720 and executed by processor 710.

In some embodiments, server infrastructure 770 may be present in computing environment 700 and may be communicatively coupled with computing device 702 via network 704. Server infrastructure 770, when present, may be a network-accessible server set (e.g., a cloud-based environment or platform). As shown in FIG. 7, server infrastructure 770 includes clusters 772. Each of clusters 772 may comprise a group of one or more compute nodes and/or a group of one or more storage nodes. For example, as shown in FIG. 7, cluster 772 includes nodes 774. Each of nodes 774 are accessible via network 704 (e.g., in a “cloud-based” embodiment) to build, deploy, and manage applications and services. Any of nodes 774 may be a storage node that comprises a plurality of physical storage disks, SSDs, and/or other physical storage devices that are accessible via network 704 and are configured to store data associated with the applications and services managed by nodes 774. For example, as shown in FIG. 7, nodes 774 may store application data 778.

Each of nodes 774 may, as a compute node, comprise one or more server computers, server systems, and/or computing devices. For instance, a node 774 may include one or more of the components of computing device 702 disclosed herein. Each of nodes 774 may be configured to execute one or more software applications (or “applications”) and/or services and/or manage hardware resources (e.g., processors, memory, etc.), which may be utilized by users (e.g., customers) of the network-accessible server set. For example, as shown in FIG. 7, nodes 774 may operate application programs 776. In an implementation, a node of nodes 774 may operate or comprise one or more virtual machines, with each virtual machine emulating a system architecture (e.g., an operating system), in an isolated manner, upon which applications such as application programs 776 may be executed.

In an embodiment, one or more of clusters 772 may be co-located (e.g., housed in one or more nearby buildings with associated components such as backup power supplies, redundant data communications, environmental controls, etc.) to form a data center, or may be arranged in other manners. Accordingly, in an embodiment, one or more of clusters 772 may be a data center in a distributed collection of data centers. In embodiments, exemplary computing environment 700 comprises part of a cloud-based platform such as Amazon Web Services® of Amazon Web Services, Inc., or Google Cloud Platform™ of Google LLC, although these are only examples and are not intended to be limiting.

In an embodiment, computing device 702 may access application programs 776 for execution in any manner, such as by a client application and/or a browser at computing device 702. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 702 may additionally and/or alternatively synchronize copies of application programs 714 and/or application data 716 to be stored at network-based server infrastructure 770 as application programs 776 and/or application data 778. For instance, operating system 712 and/or application programs 714 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 720 at network-based server infrastructure 770.

In some embodiments, on-premises servers 792 may be present in computing environment 700 and may be communicatively coupled with computing device 702 via network 704. On-premises servers 792, when present, are hosted within an organization's infrastructure and, in many cases, physically onsite of a facility of that organization. On-premises servers 792 are controlled, administered, and maintained by IT (Information Technology) personnel of the organization or an IT partner to the organization. Application data 798 may be shared by on-premises servers 792 between computing devices of the organization, including computing device 702 (when part of an organization) through a local network of the organization, and/or through further networks accessible to the organization (including the Internet). Furthermore, on-premises servers 792 may serve applications such as application programs 796 to the computing devices of the organization, including computing device 702. Accordingly, on-premises servers 792 may include storage 794 (which includes one or more physical storage devices such as storage disks and/or SSDs) for storage of application programs 796 and application data 798 and may include one or more processors for execution of application programs 796. Still further, computing device 702 may be configured to synchronize copies of application programs 714 and/or application data 716 for backup storage at on-premises servers 792 as application programs 796 and/or application data 798.

Embodiments described herein may be implemented in one or more of computing device 702, network-based server infrastructure 770, and on-premises servers 792. For example, in some embodiments, computing device 702 may be used to implement systems, clients, or devices, or components/subcomponents thereof, disclosed elsewhere herein. In other embodiments, a combination of computing device 702, network-based server infrastructure 770, and/or on-premises servers 792 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 720. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 714) may be stored in storage 720. Such computer programs may also be received via wired interface(s) 780 and/or wireless modem(s) 760 over network 704. Such computer programs, when executed or loaded by an application, enable computing device 702 to implement features of embodiments discussed herein. Accordingly, such computer programs represent controllers of the computing device 702.

Embodiments are also directed to computer program products comprising computer code or instructions stored on any computer-readable medium or computer-readable storage medium. Such computer program products include the physical storage of storage 720 as well as further physical storage types.

### VI. Additional Example Embodiments

Systems, methods, and instrumentalities described herein enable end-to-end (E2E) interactive analytics for resource allocation failures in a cloud computing environment. Resource allocation failure incidents, stemming from allocation requests, may be tracked, diagnosed, summarized and presented in near real-time for users and/or platform/service providers to understand the root cause(s) of failure incidents and actual and theoretical, failed and successful, allocation scenarios. A capacity analyzer may simulate an allocate process implemented by a resource allocation platform. The capacity analyzer may determine which resources were and/or were not eligible for allocation for a request, based on information about the resource allocation failure, the resources in the region of interest, and the constraints associated with the incident, and the resource allocation rules associated with the resource allocation platform. Users may quickly learn whether a request constraint, a requesting entity constraint, a capacity constraint, and/or a resource platform constraint caused a resource allocation incident. The capacity analyzer may proactively monitor performance and generate alerts about failed and/or successful hypothetical, prospective, retrospective, or theoretical requests that users may be interested in.

A system is described herein. The system comprises: a processor; and a memory device that stores program code configured to be executed by the processor, the program code comprising: a resource manager, of a resource allocation platform, configured to receive a request by a requesting entity for a resource allocation; an incident manager configured to track an incident of resource allocation failure for the request; a capacity analyzer configured to determine at least one cause of the incident, the capacity analyzer configured to extract activity information for the incident to identify at least one further allocation failure associated with the incident, retrieve resource information of clusters related to each allocation failure, and perform validations based on the retrieved resource information to determine cluster eligibility for deployment; and a summarizer configured to generate information, based on the determined at least one cause, that indicates a plurality of allocation scenarios for the incident, including an actual failed allocation scenario associated with the request and at least one of a prospective or a retrospective allocation scenario.

In examples, the program code may further comprise: a user interface configured to present a recommended action to mitigate failure risks and to provide interactive visual analysis for users to understand and implement mitigation to enable improved allocation success rates.

In examples, the program code may further comprise: a user interface configured to present the information indicating the plurality of allocation scenarios including a successful allocation scenario, the user interface further configured to support interaction with the information to determine the successful allocation scenario.

In examples, the program code may (e.g., further) comprise a data collector configured to collect incident information. The capacity analyzer may be configured to determine the at least one cause of the incident based on the incident information.

In examples, the incident manager may be configured to trigger operation of the capacity analyzer.

In examples, the capacity analyzer may be configured to determine the at least one cause of the incident by applying resource allocation rules for the resource platform.

In examples, the resource allocation rules may comprise resource platform domain knowledge that simulates a resource allocation process of the resource platform.

In examples, the capacity analyzer may be configured to determine the at least one cause of the incident by: determining resources in a region associated with the incident; determining constraints associated with the incident comprising at least one of a request constraint, a requesting entity constraint, a capacity constraint, or a resource platform constraint; determining resource allocation rules associated with the resource allocation platform at the time of the request; and determining which resources were or were not eligible for allocation for the request, based on the resource allocation failure, the resources, the constraints associated with the incident, and the resource allocation rules associated with the resource allocation platform.

A method may be implemented in a computing device. The method comprises: tracking an incident of resource allocation failure for a request by a requesting entity for allocation of resources from a resource allocation platform; determining at least one cause of the incident by extracting activity information for the incident to identify at least one further allocation failure associated with the incident, retrieving resource information of clusters related to each allocation failure, and performing validations based on the retrieved resource information to determine cluster eligibility for deployment; and generating information, based on the determined at least one cause, that indicates a plurality of allocation scenarios for the incident, including an actual failed allocation scenario associated with the request and at least one of a prospective or a retrospective allocation scenario.

In examples, the method may further comprise presenting the information indicating the plurality of allocation scenarios in a user interface.

In examples, the presenting may comprise presenting a successful allocation scenario associated with the request; or supporting interaction with the information by the user interface to determine the successful allocation scenario.

In examples, the method may further comprise collecting incident information for the incident, wherein said determining at least one cause of the incident is based on the incident information.

In examples, the determining of the at least one cause of the incident may be triggered by the tracking of the incident.

In examples, the determination of the at least one cause of the incident may comprise applying resource allocation rules for the resource platform.

In examples, the allocation rules may comprise resource platform domain knowledge that simulates a resource allocation process of the resource platform.

In examples, the determining of the at least one cause of the incident may comprise: determining resources in a region associated with the incident; determining constraints associated with the incident comprising at least one of a request constraint, a requesting entity constraint, a capacity constraint, or a resource platform constraint; determining resource allocation rules associated with the resource allocation platform at the time of the request; and determining which resources were or were not eligible for allocation for the request, based on the resource allocation failure, the resources, the constraints associated with the incident, and the resource allocation rules associated with the resource allocation platform.

A computer-readable storage medium is described herein. The computer-readable storage medium has program instructions recorded thereon that, when executed by a processor, implement a method comprising: tracking an incident of resource allocation failure for a request by a requesting entity for allocation of resources from a resource allocation platform; determining at least one cause of the incident by extracting activity information for the incident to identify at least one further allocation failure associated with the incident, retrieving resource information of clusters related to each allocation failure, and performing validations based on the retrieved resource information to determine cluster eligibility for deployment; and generating information, based on the determined at least one cause, that indicates a plurality of allocation scenarios for the incident, including a failed allocation scenario associated with the request and at least one of a prospective or a retrospective allocation scenario.

In examples, the method may further comprise presenting the information indicating the plurality of allocation scenarios in a user interface

In examples, the determining of the at least one cause of the incident may occur by applying resource allocation rules for the resource platform. The resource allocation rules may comprise resource platform domain knowledge that simulates a resource allocation process of the resource platform.

In examples, the determining of the at least one cause of the incident may comprise: determining resources in a region associated with the incident; determining constraints associated with the incident comprising at least one of a request constraint, a requesting entity constraint, a capacity constraint, or a resource platform constraint; determining resource allocation rules associated with the resource allocation platform at the time of the request; and determining which resources were or were not eligible for allocation for the request, based on the resource allocation failure, the resources, the constraints associated with the incident, and the resource allocation rules associated with the resource allocation platform.

### VII. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

For example, running examples have been described with respect to malicious activity detectors determining whether compute resource creation operations potentially correspond to malicious activity. However, it is also contemplated herein that malicious activity detectors may be used to determine whether other types of control plane operations potentially correspond to malicious activity.

Several types of impactful operations have been described herein; however, lists of impactful operations may include other operations, such as, but not limited to, accessing enablement operations, creating and/or activating new (or previously-used) user accounts, creating and/or activating new subscriptions, changing attributes of a user or user group, changing multi-factor authentication settings, modifying federation settings, changing data protection (e.g., encryption) settings, elevating another user account's privileges (e.g., via an admin account), retriggering guest invitation e-mails, and/or other operations that impact the cloud-base system, an application associated with the cloud-based system, and/or a user (e.g., a user account) associated with the cloud-based system.

Moreover, according to the described embodiments and techniques, any components of systems, computing devices, servers, device management services, virtual machine provisioners, applications, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

1. A system, comprising:
a processor; and
a memory device that stores program code configured to be executed by the processor, the program code comprising:
a resource manager, of a resource allocation platform, configured to receive a request by a requesting entity for a resource allocation;
an incident manager configured to track an incident of resource allocation failure for the request;
a capacity analyzer configured to determine at least one cause of the incident by:
extracting activity information for the incident to identify a prior allocation failure associated with the incident,
retrieving resource information of clusters related to each allocation failure, and
performing validations based on the retrieved resource information to determine cluster eligibility for deployment; and
a summarizer configured to generate information, based on the determined at least one cause, that indicates a plurality of allocation scenarios for the incident, including an actual failed allocation scenario associated with the request and at least one of a prospective or a retrospective allocation scenario.

2. The system of claim 1, the program code further comprising:
a user interface configured to present a recommended action to mitigate failure risks and to provide interactive visual analysis for users to understand and implement mitigation to enable improved allocation success rates.

3. The system of claim 1, the program code further comprising:
a user interface configured to present the information indicating the plurality of allocation scenarios including a successful allocation scenario, the user interface further configured to support interaction with the information to determine the successful allocation scenario.

4. The system of claim 1, the program code further comprising:
a data collector configured to collect incident information,
wherein the capacity analyzer is configured to determine the at least one cause of the incident based on the incident information.

5. The system of claim 1, wherein the incident manager is configured to trigger operation of the capacity analyzer.

6. The system of claim 1, wherein the capacity analyzer is configured to determine the at least one cause of the incident by applying resource allocation rules for the resource platform.

7. The system of claim 6, wherein the resource allocation rules comprise resource platform domain knowledge that simulates a resource allocation process of the resource platform.

8. The system of claim 1, wherein the capacity analyzer is configured to determine the at least one cause of the incident by:
determining resources in a region associated with the incident;
determining constraints associated with the incident comprising at least one of a request constraint, a requesting entity constraint, a capacity constraint, or a resource platform constraint;
determining resource allocation rules associated with the resource allocation platform at the time of the request; and
determining which resources were or were not eligible for allocation for the request, based on the resource allocation failure, the resources, the constraints associated with the incident, and the resource allocation rules associated with the resource allocation platform.

9. A method comprising:
tracking an incident of resource allocation failure for a request by a requesting entity for allocation of resources from a resource allocation platform;
determining at least one cause of the incident by
extracting activity information for the incident to identify at least one further allocation failure associated with the incident,
determining a region associated with the incident and each allocation failure,
determining resources in the region and related to each allocation failure,
determining a constraint associated with the region, and
determining eligibility for deployment based on the constraint associated with the region; and
generating information, based on the determined at least one cause, that indicates a plurality of allocation scenarios for the incident, including an actual failed allocation scenario associated with the request and at least one of a prospective or a retrospective allocation scenario.

10. The method of claim 9, further comprising:
presenting the information indicating the plurality of allocation scenarios in a user interface.

11. The method of claim 10, wherein the presenting comprises:
presenting a successful allocation scenario associated with the request; or
supporting interaction with the information by the user interface to determine the successful allocation scenario.

12. The method of claim 9, further comprising:
collecting incident information for the incident, wherein the determining of the at least one cause of the incident is based on the incident information.

13. The method of claim 9, wherein the determining of the at least one cause of the incident is triggered by the tracking of the incident.

14. The method of claim 9, wherein the determining of the at least one cause of the incident comprises:
applying resource allocation rules for the resource platform.

15. The method of claim 14, wherein the allocation rules comprise resource platform domain knowledge that simulates a resource allocation process of the resource platform.

16. The method of claim 9, wherein:
the constraint associated with the region comprises at least one of a request constraint, a request entity constraint, a capacity constraint, or a resource platform constraint; and
the determining of the at least one cause of the incident comprises:
determining resource allocation rules associated with the resource allocation platform at the time of the request; and
determining which resources were or were not eligible for allocation for the request, based on the resource allocation failure, the resources, the constraint associated with the region, and the resource allocation rules associated with the resource allocation platform.

17. A computer-readable storage medium having program instructions recorded thereon that, when executed by a processor, implement a method comprising:
tracking an incident of resource allocation failure for a request by a requesting entity for allocation of resources from a resource allocation platform;
determining at least one cause of the incident by
extracting activity information for the incident to identify a prior allocation failure associated with the incident,
retrieving resource information of clusters related to each allocation failure, and
performing validations based on the retrieved resource information to determine cluster eligibility for deployment; and
generating information, based on the determined at least one cause, that indicates a plurality of allocation scenarios for the incident, including a failed allocation scenario associated with the request and at least one of a prospective or a retrospective allocation scenario.

18. The computer-readable storage medium of claim 17, the method further comprising:
presenting the information indicating the plurality of allocation scenarios in a user interface.

19. The computer-readable storage medium of claim 17, wherein the determining of the at least one cause of the incident occurs by applying resource allocation rules for the resource platform, and wherein the resource allocation rules comprise resource platform domain knowledge that simulates a resource allocation process of the resource platform.

20. The computer-readable storage medium of claim 17, wherein the determining of the at least one cause of the incident comprises:
determining resources in a region associated with the incident;
determining constraints associated with the incident comprising at least one of a request constraint, a requesting entity constraint, a capacity constraint, or a resource platform constraint;
determining resource allocation rules associated with the resource allocation platform at the time of the request; and
determining which resources were or were not eligible for allocation for the request, based on the resource allocation failure, the resources, the constraints associated with the incident, and the resource allocation rules associated with the resource allocation platform.
